(19) United States
(12) Patent Application Publication
(10) Pub. No.: US 2018/0139551 A1
(43) Pub. Date: May 17, 2018

(54) CAPACITIVE MEMBRANE POSITIONING TRACKING

(71) Applicant: Sound Solutions International Co., Ltd., Beijing (CN)

(72) Inventor: Friedrich Reining, Vienna (AT)

(21) Appl. No.: 15/572,340

(22) PCT Filed: May 9, 2016
(86) PCT No.: PCT/CN2016/081395

§ 371 Date: Nov. 7, 2017

Related U.S. Application Data
(60) Provisional application No. 62/158,772, filed on May 8, 2015.

(51) Int. Cl. H04R 29/00; H04R 9/06; H04R 7/10

(52) U.S. Cl. CPC H04R 29/001; H04R 2499/11; H04R 7/10; H04R 9/06

(57) ABSTRACT

A loudspeaker(1) relates to a capacitive membrane(2) positions tracking used in a standard electro-dynamical speaker and offers an additional way of sensing the speaker(1) via the electric interface. State of the art techniques use the voice coil for sensing the speakers' impedance. There are double coil setups where a second coil layer is wound over the whole height of the voice coil in order to maximize power by a given battery voltage. The loudspeaker(1) is based on a capacitive principle found within state of the art C-microphones, but incorporated in the membrane plate which is used by now for stiffening the membrane(2). A simple two wire interface senses the position and requires only few components.

### BACKGROUND OF THE INVENTION

### Field of the Invention

The invention relates to an audio transducer, such as a speaker to transduce an electrical audio signal into acoustic sound or a receiver to transduce an acoustic sound into an electrical audio signal. This invention furthermore relates to a micro speaker optimized for high acoustic output and located within a small volume of a mobile device, such as a mobile phone, a tablet, a gaming device, a notebook or similar device. As the physical volume within these mobile devices is very limited and as the audio transducer has to fit into the housing of the mobile device together with other modules having rectangular shapes, the micro speaker quite often must be constructed having a rectangular form factor.

### Background Art

When maximizing the performance of a speaker by means of output power, linearity and robustness, limitations given by the design of the speaker need to be taken into account. Using the electrical interface as a driver to drive the membrane and as a sensor to sense the actual position of the membrane at the same time is well-known and used in several sophisticated class D amplifiers that model the loudspeaker based on static as well as dynamically gathered parameters through the electrical interface. Some prior art speakers comprise a sensor to sense the position of the membrane in the speaker. The sensor signal may be used to track the actual deflection of the membrane and to avoid deflections that are too large. Such large deflections may cause the membrane to touch the housing of the speaker or the top plate of the magnet located beneath the membrane, both of which result in a distorted sound being emitted from the speaker. The sensor signal may be fed into the amplifier that amplifies the audio signal being fed into the voice coil of the speaker in order to avoid such large deflections of the membrane.

In some prior art speakers, a sensor comprises a second coil layer wound over the whole height of the voice coil that drives the membrane to generate sound. The magnetic flux of the magnet system of the speaker induces a membrane voltage in both coils based on the position of the coil in relation to the magnet system which is not equally distributed over the moving range of the coils. This type of sensor has the disadvantage that the second coil adds cost and technical complexity to the speaker and that the second coil increases the weight of the moving part of the speaker, thereby reducing the acoustic sound output power of the speaker.

Another sensor in prior art loudspeakers uses laser light to measure the varying distance of the membrane. This type of sensor is only used for large speakers and it increases the costs and technical complexity of the speaker substantially.

### SUMMARY OF THE INVENTION

It is an object of the invention to have an audio transducer for mobile devices without the disadvantages of known transducers. A new audio transducer for mobile devices, in particular for a micro speaker, comprises a sensor for sensing the position of the membrane using the capacitance between a membrane plate and a top plate, which is part of the magnetic system of the speaker. An advantage of this new sensor is that mechanical elements already part of the speaker are used to form a capacitor which capacitance changes with the position of the membrane within the speaker. This helps to keep the weight of the moving parts of the speaker low and the quality of sound emitted high. Further details and advantages of such an audio transducer will become apparent in the following description and the accompanying drawings.

The foregoing and other aspects, features, details, utilities, and advantages of the present invention will be apparent from reading the following description and claims, and from reviewing the accompanying drawings.

### BRIEF DESCRIPTION OF THE DRAWINGS

Further embodiments of the invention are indicated in the figures and in the dependent claims. The invention will now be explained in detail by the drawings. In the drawings:

FIG. 1 shows an exploded perspective view of the relevant parts of a prior art rectangular micro speaker.

FIG. 2A shows a sectional view of the relevant parts of a rectangular micro speaker with a sensor to track the position of the membrane according to a first embodiment of the invention.

FIG. 2B shows an enlarged view of the sensor within a portion of the membrane of the speaker of FIG. 2A.

FIG. 3 shows a perspective view of a portion of the speaker of FIG. 2A.

FIG. 4 shows a perspective view of a flexible circuit embedded in the membrane of the speaker of FIG. 2A.

FIG. 5 shows a diagram of the electrical circuit of the sensor in the speaker of FIG. 2A.

FIG. 6 shows the sensor signal of the speaker of FIG. 2A.

FIG. 7 shows a sectional view of the relevant parts of a rectangular micro speaker with a sensor to track the position of the membrane according to a second embodiment of the invention with an enlarged view of the sensor within a portion of the top plate.

FIG. 8 shows a top view of the top plate of FIG. 7 with one centric sensor to track the position of the membrane.

FIG. 9 shows a top view of the top plate of FIG. 7 with three sensors to track the position of the membrane.

FIG. 10 shows a sectional view of a variation of the rectangular micro speaker of FIG. 7 with added shielding.

### DETAILED DESCRIPTION OF EMBODIMENTS

Various embodiments are described herein to various apparatuses. Numerous specific details are set forth to provide a thorough understanding of the overall structure, function, manufacture, and use of the embodiments as described in the specification and illustrated in the accompanying drawings. It will be understood by those skilled in the art, however, that the embodiments may be practiced without such specific details. In other instances, well-known operations, components, and elements have not been described in detail so as not to obscure the embodiments described in the specification. Those of ordinary skill in the art will understand that the embodiments described and illustrated herein are non-limiting examples, and thus it can be appreciated that the specific structural and functional details disclosed herein may be representative and do not necessarily limit the scope of the embodiments, the scope of which is defined solely by the appended claims.

Reference throughout the specification to “various embodiments,” “some embodiments,” “one embodiment,” or “an embodiment,” or the like, means that a particular feature, structure, or characteristic described in connection with the embodiment is included in at least one embodiment. Thus, appearances of the phrases “in various embodiments,” “in some embodiments,” “in one embodiment,” or “in an embodiment,” or the like, in places throughout the specification are not necessarily all referring to the same embodiment. Furthermore, the particular features, structures, or characteristics may be combined in any suitable manner in one or more embodiments. Thus, the particular features, structures, or characteristics illustrated or described in connection with one embodiment may be combined, in whole or in part, with the features, structures, or characteristics of one or more other embodiments without limitation given that such combination is not illogical or non-functional.

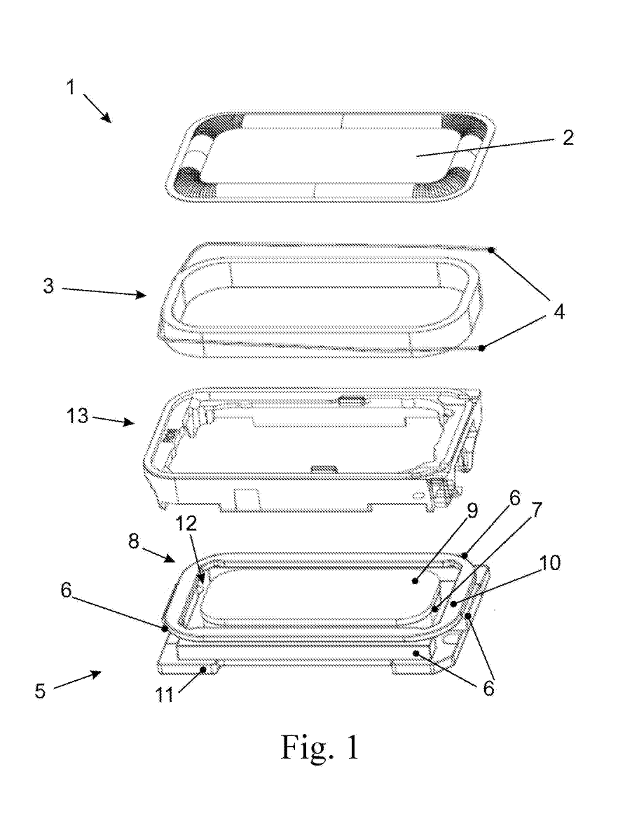

FIG. 1 shows an exploded perspective view of the relevant parts of a prior art rectangular micro speaker 1. Speaker 1 comprises a membrane 2 that is typically built out of several layers like Ethere Ketone (PEEK) and/or Acrylat and/or Thermoplastic Elastomeric (TEP) and/or Polyetherimide (PEI) and may comprise a membrane plate (not shown) to stiffen the membrane 2. Speaker 1 furthermore comprises a voice coil 3 with leads 4 to feed an electrical signal into voice coil 3. Voice coil 3 of assembled speaker 1 is fixed to membrane 2 with e.g. glue.

Speaker 1 comprises a magnet system 5 with four magnets 6 arranged on the rectangular sides of the rectangular speaker 1 and a magnet 7 arranged in the center of speaker 1. Magnet system 5 furthermore comprises magnetic field guiding means 8 comprising top plate 9 fixed to magnet 7, ring plate 10 fixed to magnets 6, and pot plate 11 fixed to magnets 6 on the side opposite to ring plate 10. Field guiding means 8 guides and focuses the magnetic field of magnets 6 and 7 in an air gap 12, into which air gap 12 voice coil 3 is arranged in the assembled speaker 1.

Prior art micro speaker 1 further comprises frame 13 to assemble and align membrane 2 with magnet system 5. Voice coil 3 fixed to membrane 2 fits into air gap 12. Frame 13 typically is made from a molded plastic to enable the complex surface with openings to enable airflow and fixation of further parts of speaker 1. The ends of leads 4 of voice coil 3 are soldered with a contact pad, not shown in FIG. 1, that is fixed in frame 13 during an assembly process.

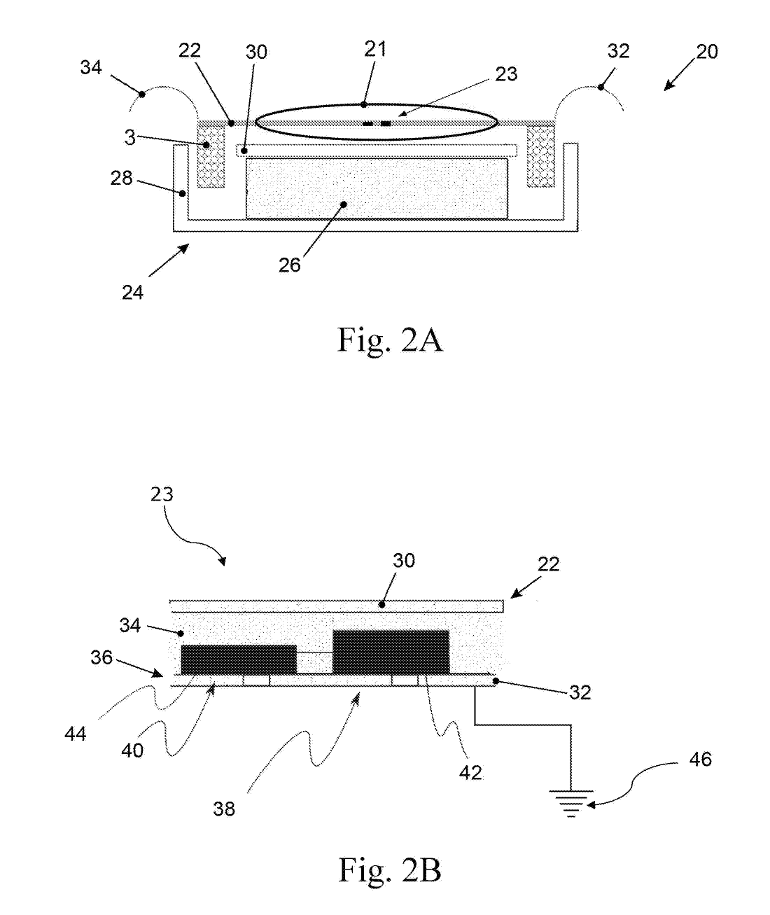

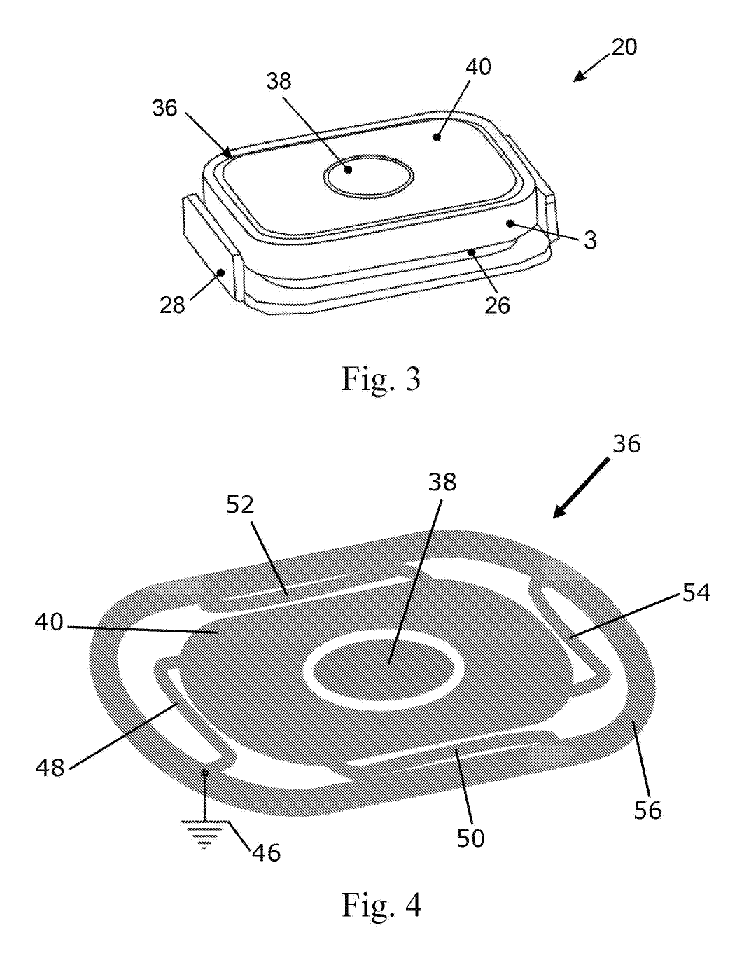

The relevant parts of a first embodiment of the invention is shown in FIGS. 2A, 2B and 3. FIG. 2A shows a sectional view of the relevant parts of a rectangular speaker 20. FIG. 2B shows an enlarged view of the area 21 of FIG. 2A while FIG. 3 shows a perspective view of the relevant parts of speaker 20. The speaker 20 comprises a voice coil 3, a membrane 22 and a magnet system 24. A sensor 23 is located within the membrane 22 in order to track the position of the membrane 22. The magnet system 24 comprises a magnet 26 located underneath the membrane and field guiding means comprised of a pot 28 and a top plate 30 mounted onto opposite sides of magnet 26. Leads 32 and 34 connect the voice coil 3 to a driver circuit (not shown) that feeds the electrical audio signal into the voice coil 3.

The layered construction of membrane 22 is shown in the enlarged view of FIG. 2B. Membrane 22 comprises an upper face-sheet layer 30, a lower face-sheet layer 32 and a middle layer 34. Both the upper face-sheet layer 30 and the lower face-sheet layer 32 function as a membrane plate to stiffen membrane 22. The middle layer 34, or core of the membrane 22, is comprised of a polymer material. In prior art layered construction membranes, both an upper face-sheet layer and a lower face-sheet layer are comprised of an aluminum foil since aluminum is not magnetic and has good material properties to stiffen the membrane with limited weight. However, the invention is not limited to aluminum face-sheet layers and other materials are possible and contemplated.

In an embodiment, upper face-sheet layer 30 of membrane 22 is comprised of an aluminum foil while lower face-sheet layer 32 is comprised of a flexible circuit 36 that serves two functions. The flexible circuit 36 both stiffens membrane 22 similar to the function of an aluminum foil, and supports the electronic components of sensor 23. Flexible circuit 36 comprises a gate area 38 electrically separated from a ground area 40. The sensor 23 further comprises field effect transistor 42 and Ohmic resistor 44.

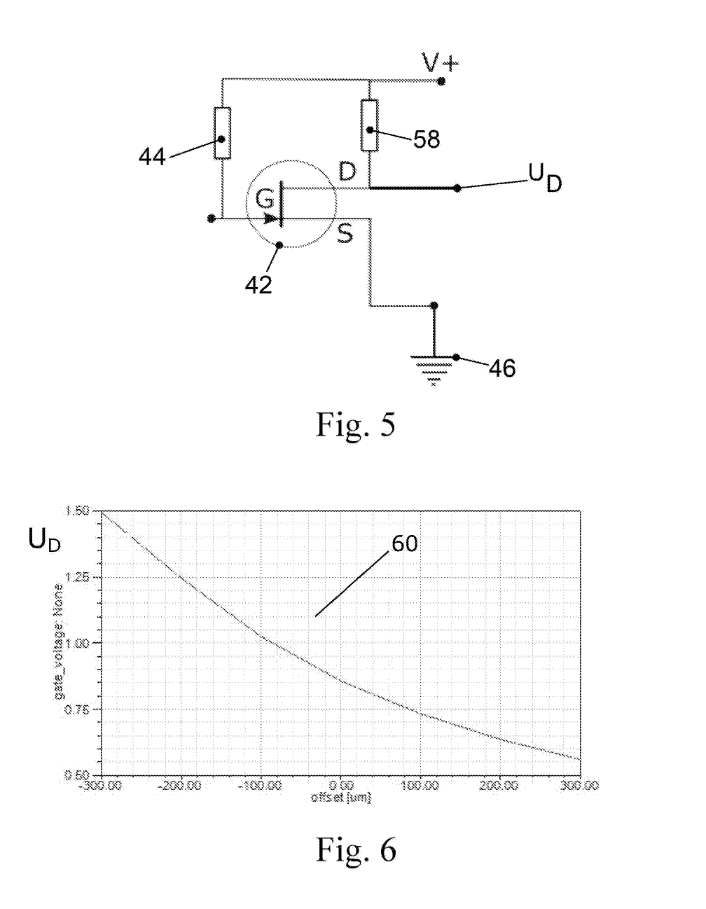

As show in FIG. 2B and depicted in the circuit in FIG. 5, field effect transistor 42 is connected with its gate G to gate area 38 of the flexible circuit 36, and with its source S to ground area 40 of flexible circuit 36. Ground area 40 is in turn connected to electrical ground 46. Ohmic resistor 44 is electrically connected on one side to a supply voltage source (not shown) and on the other side to gate G of field effect transistor 42.

Top plate 30 is also connected to electrical ground 46. Together top plate 30 and gate area 38 of the flexible circuit 36 form a capacitor that changes its capacity based on the distance between gate area 38 and the top plate 30, and thus can be used to measure the position of membrane 22 within speaker 20.

The electrical connections for the components of sensor 23 and the leads 32, 34 for voice coil 3 to the stationary frame holding speaker 20 are not shown in the FIGS. 2A, 2B and 3. However, such connections must be able to withstand the stresses that will result from movement of the voice coil 3 and vibration of the membrane 22 (and the sensor 23 located inside of it) during operation. One method for the electrical connections is through flexible circuit 36, and in particular the configuration of flexible circuit 36 as shown in FIG. 4.

Flexible circuit 36 in FIG. 4 comprises gate area 38 electrically isolated from ground area 40 and a plurality of flexible spider arms 48, 50, 52, 54 arranged around the ground area 40. Spider arms 48, 50, 52, 54 are physically connected to outer ring 56 around the periphery of flexible circuit 36. Membrane 22 is attached to the frame (not shown) holding speaker 20 via the outer ring 56. The spider arms 48, 50, 52, 54 allow for membrane 22, including ground area 40 and gate area 38, to vibrate while outer ring 56 is stationary on the frame.

Spider arms 48, 50, 52, 54 are also used to carry the electrical connections for sensor 23 and voice coil 3. In an embodiment shown in FIG. 4, contact 32 of voice coil 3 is connected via spider arm 48 with electrical ground 46. Contact 34 of voice coil 3 is connected via spider arm 52 to a first contact pad (not shown) on the frame holding speaker 20 for input of the electrical audio signal that drives speaker 20. Ohmic resistor 44 is connected via spider arm 50 to a second contact pad (not shown) on the frame holding speaker 20 for a supply voltage source. And the drain connection of field effect transistor 42 is connected via spider arm 54 to a third contact pad (not shown) on the frame holding speaker 20 for output of the signal of sensor 23.

FIG. 5 shows a diagram of the electrical circuit of sensor 23 used to sense the position of membrane 22 in speaker 20. Supply voltage V+is, for example, 3 volts, and feeds voltage into Ohmic resistor 44, which is in the range of several 100 MOhm, and into Ohmic resistor 58, which is in the range of several kOhm. Resistor 44 allocates charged carriers onto electrically isolated gate area 38, which is connected to gate G of field effect transistor 42. Resistor 58 is also connected to drain D of field effect transistor 42. Source S of field effect transistor 42 is connected to electrical ground 46.

The function of the sensor 23 is as follows. Gate area 38 connected to gate G of field effect transistor 42 is charged via resistor 44 with a very small current defined by the high Ohmic resistance of resistor 44. The distance between gate area 38 and top plate 30 connected to electrical ground 46 changes fast as membrane 22 moves with a frequency in the acoustic area (20 Hz to 20 kHz). As a result, electric potential on gate G changes equivalent to the movement of membrane 22 and modulates the current flow between drain D and source S of the field effect transistor 42. The graph of FIG. 6 shows a plot of the sensor signal 60 represented by the voltage U_{D} as a function of the offset (in micrometers) of membrane 22.

In principle it would be possible to use the complete lower face-sheet layer 32 as a gate area, but it is advantageous to shield gate area 38 with ground area 40 and upper face-sheet layer 30 against electromagnetic interference. This not only improves the quality of sensor signal 60, but is essential that the waveform of the signal strongly correlates with the actual displacement of the membrane. Any corruption of the signal (e.g., spurious impulses from a display driver in a mobile phone) will lead to under- or overestimation of the actual position of the membrane. It is furthermore advantageous to insert the electronic components of the sensor 23 into membrane 22 in order to prevent the high impedance area of gate area 38 getting covered by electromagnetic noise in one of the spider arms.

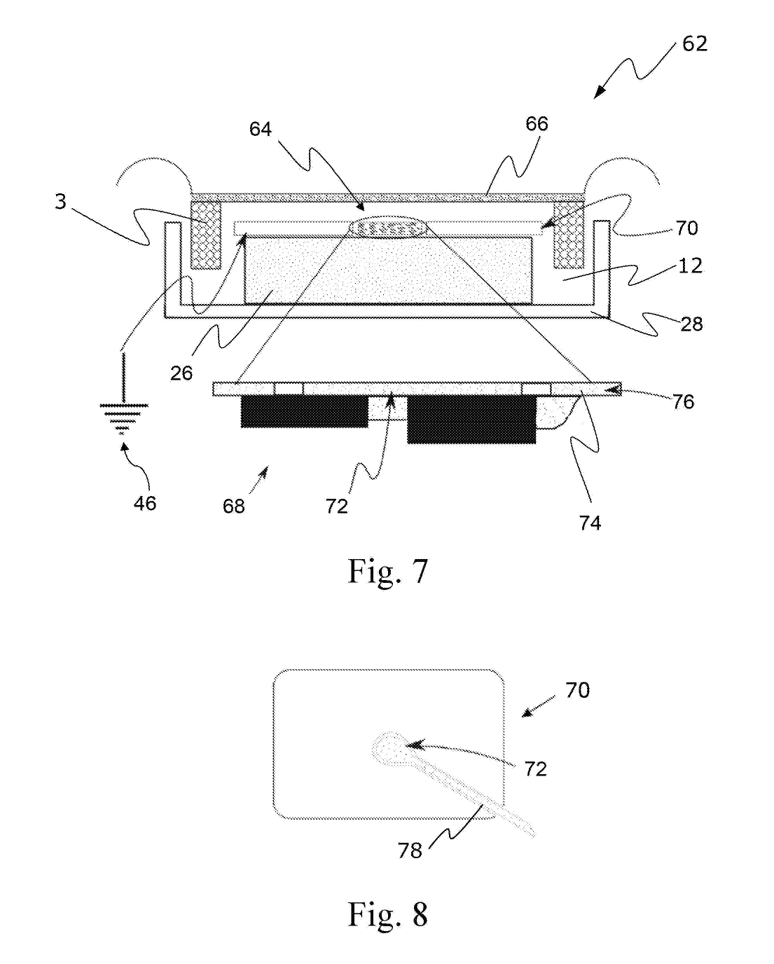

FIG. 7 shows a sectional drawing of the relevant parts of a rectangular micro speaker 62 with a sensor 64 to track the position of the membrane 66 according to a second embodiment of the invention. In this embodiment the electronic components 68 of the sensor 64 are incorporated into a clearance in top plate 70. The primary function of top plate 70 is to focus the magnetic field into air gap 12. A clearance formed in the middle of the top plate 70 to house the electronic components 68 should not impact the resulting magnetic field in the air gap 12. Locating the electronic components 68 in a clearance in the top plate 70 instead of on top of the top plate 70 has the advantage that the distance between the lower face-sheet layer of membrane 66 and top plate 70 is not reduced in order to enable maximal acoustic output of speaker 62. It is furthermore advantageous to place the electric components 68 into top plate 70 because this reduces the weight of membrane 66 compared to the weight of membrane 22 and increases the dynamics of speaker 62.

Gate area 72 and ground area 74 are electrically created on a flexible circuit 76, which means that there needs to be a low resistive electrical connection between the top plate 70 and the flexible circuit 76 holding the electronics. The lower face-sheet layer of membrane 66 is a single layer, for example, of aluminum foil, which acts as shielding and needs to be connected to electrical ground as well. This connection can be easily achieved when the micro speaker 62 is connected to a Class AB amplifier because one of the connections of voice coil 3 will be connected to electrical ground through the amplifier.

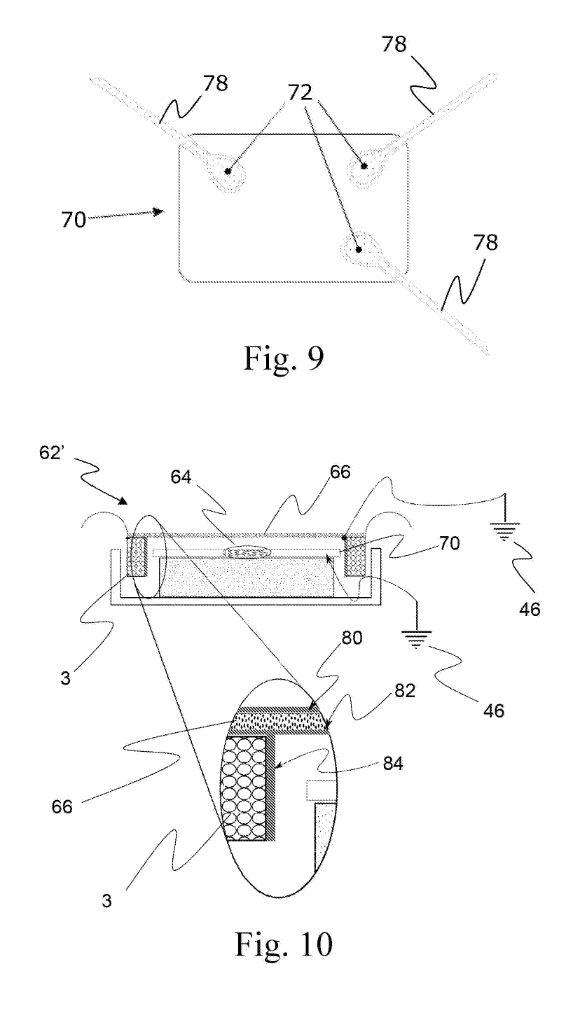

In the micro speaker 62 depicted in FIG. 7, the gate area 72 on the flexible circuit 76 is shown in the center of the top plate 70 and thus, the capacitive sensor 64 tracks the position of the center of the membrane. FIG. 8 depicts a top view of the top plate 70 shown in FIG. 7, with gate area 72 of capacitive sensor 64 positioned in the center of top plate 70. Electrical connection to the gate area 72 is facilitated by a three-wire interface 78. It may be desirable to track areas in addition to or instead of the center of the membrane. Further, it may be advantages to include more than one gate area 72. FIG. 9 shows a top view of top plate 70 with three gate areas 72 of three capacitive sensors 64 to track three corner positions of the membrane 66. A three-wire interface 78 provides electrical connection to each gate area 72. It is advantageous to have more than only one capacitive sensor on one membrane or on the top plate to enable detection of tumbling of the membrane.

Speakers according to further embodiments of the invention could comprise two or four or even more gate areas of sensors to measure the movement of different parts of the membrane. The lower face-sheet layer of a membrane could be realized in another way than with a flexible circuit.

Speakers according to further embodiments of the invention could comprise a gate area with a fixed doped dielectric material like in electret microphones. This provides the advantage that there would be no need for resistor 44.

It is noted above that the lower face-sheet layer of membrane 66 can be connected to electrical ground 46 through the connections of voice coil 3 when the micro speaker 62 is connected to a Class AB amplifier. In that instance, the capacitive sensor 64 will be shielded by the lower face-sheet layer of membrane 66, the voice coil 3 and the top plate 70. The shielding is not perfect, however, because the resistance between the grounding connections are in the range of the voice coil impedance. Nevertheless, the shielding is sufficient to raise the signal-to-noise ratio of the sensor signal by several decibels.

In mobile applications, however, it is more common to use Class D amplifiers, in which case there is no ground signal because both connections to the speaker are switched. Thus, an alternative method to minimize the impact of highly transient high power signals within the mobile device environment is required.

FIG. 10 shows one such method to provide shielding to the capacitive sensor 64. In micro speaker 62′, most of the components are the same as in micro speaker 62. Membrane 66 comprises an upper face-sheet layer 80 and a lower face-sheet layer 82 which function as a membrane plate to stiffen membrane 66. Both the upper and lower face-sheet layers 80, 82 may be comprised of an aluminum foil or other conductive foil. A conductive layer 84 is applied to the inside surface of the voice coil 3 and is electrically connected to the lower face-sheet layer 82. The lower face-sheet layer 82 is in turn connected to the electrical ground 46 of the electronic components 68 of the sensor 64. As opposed to micro speaker 62, an additional electrical connection between the moving part of the micro speaker 62′ (i.e., the membrane 66 and voice coil 3) to the magnet stack (i.e., magnet 26 and top plate 70) is required to make the connection to electrical ground 46 for the lower face-sheet layer 82.

The conductive layer 84 can also be made of aluminum or other conductive material. Further, the conductive layer 84 may be part of the lower face-sheet layer 82, which might be simply folded during the process of attaching the voice coil 3 to the membrane 66. Additionally, the conductive layer 84 may be a conductive color, paint or other coating applied to the inner side of the voice coil 3. It is desirable for the conductive layer 84 to have a low resistance and be as thin as possible to have minimal intrusion into the air gap 12 and thus minimal loss to the sensitivity of the performance of the micro speaker 62′.

The circuit described above and depicted in the figures may be particularly useful in frequency ranges greater than 1 Hz but not as practical in lower frequencies due to the high-pass behavior of the impedance converting component.

Where operation at very low frequencies is desired, a sensor circuit that can detect capacitance change rates down to 0 Hz is desirable. One such a circuit may employ frequency modulation of an oscillator in the RF region, which is not limited by a low cutoff frequency.

Different methods for readout of sensor capacitance at 0 Hz exist, including an oscillator principle, time constant measurement, a Schering Bridge and charging the capacitance with known charge. Example implementations of these methods, especially using a microcontroller, are described in Milosavljević, V., Mihajlović, Ž., Rajs, V., Živanov, M. (2011, September) Solution of Capacitive Touch Panel for Robust Industrial and Public Usage, Proceedings of the XV International Scientific Conference on Industrial Systems, Sep. 14-16, 2011, Novi Sad, Serbia, pp. 140-144.

In closing, it should be noted that the invention is not limited to the above mentioned embodiments and exemplary working examples. Further developments, modifications and combinations are also within the scope of the patent claims and are placed in the possession of the person skilled in the art from the above disclosure. Accordingly, the techniques and structures described and illustrated herein should be understood to be illustrative and exemplary, and not limiting upon the scope of the present invention. The scope of the present invention is defined by the appended claims, including known equivalents and unforeseeable equivalents at the time of filing of this application.

1. A loudspeaker device comprising:
a magnet system, the magnet system comprising:
a pot having a first horizontal side and at least two vertical sides connected to the first horizontal side, the vertical sides being substantially parallel to each other and substantially perpendicular to the first horizontal side;
a permanent magnet located on the first horizontal side of the pot; and
a top plate fixed to the permanent magnet;
a voice coil disposed around the permanent magnet and in a space defined by the permanent magnet and the vertical sides of the pot;
a membrane attached to the voice coil; and
a capacitive sensor configured to track the position of the membrane relative to the top plate.

2. The loudspeaker device of claim 1, wherein the capacitive sensor comprises electronic components embedded in the membrane.

3. The loudspeaker device of claim 2 wherein the capacitive sensor comprises a gate area and wherein the gate area and the top plate form a capacitor that changes its capacity based on the distance between the gate area and the top plate.

4. The loudspeaker device of claim 3 wherein the membrane comprises:
a lower face-sheet layer facing the permanent magnet;
an upper face-sheet layer; and
at least one middle layer between the lower and upper face-sheet layers.

5. The loudspeaker device of claim 4 wherein the lower face-sheet layer comprises a flexible circuit, the flexible circuit being electrically coupled to the electronic components of the capacitive sensor.

6. The loudspeaker device of claim 5, wherein the flexible circuit comprises:
a ground area electrically coupled to electrical ground;
a gate area sounded by the ground area and electrically isolated from the ground area;
an outer ring on the periphery of the flexible circuit; and
a plurality of spring arms mechanically connecting the outer ring to the ground area, the spring arms configured to provide electrical connections to the electronic components of the capacitive sensor,
wherein the flexible circuit is configured to allow the ground area and gate area to move in a transverse direction relative to the outer ring.

7. The loudspeaker device of claim 2, wherein the electronic components comprise an Ohmic resistor and a field effect transistor.

8. The loudspeaker device of claim 7 wherein the Ohmic resistor has a resistance greater than 100 MOhm.

9. The loudspeaker device of claim 8 wherein the Ohmic resistor has a resistance greater than 200 MOhm.

10. The loudspeaker device of claim 9 wherein the Ohmic resistor has a resistance greater than 200 MOhm.

11. The loudspeaker device of claim 1 wherein the capacitive sensor comprises electronic components located in a clearance in the top plate.

12. The loudspeaker device of claim 11 wherein the capacitive sensor comprises a gate area and wherein the gate area and the membrane form a capacitor that changes its capacity based on the distance between the gate area and the membrane.

13. The loudspeaker device of claim 11 further comprising a shielding layer applied to an inner surface of the voice coil facing the permanent magnet, wherein the shielding layer is electrically conductive and electrically coupled to electrical ground.

14. The loudspeaker device of claim 13, wherein the membrane comprises at least two layers of different materials, with the layer facing the permanent magnet being a conductive layer, and wherein the shielding layer is integrally formed with the conductive layer of the membrane.

15. The loudspeaker device of claim 13 wherein the shielding layer is a conductive coating.

16. The loudspeaker device of claim 13 wherein the shielding layer is an aluminum foil.
